(19) United States
(12) Patent Application Publication
(10) Pub. No.: US 2015/0049423 A1
(43) Pub. Date: Feb. 19, 2015

(54) KEYBOARD MODULE CAPABLE OF SUPPORTING A PORTABLE ELECTRONIC DEVICE

(71) Applicant: BUNGBUNGAME INC., Taipei City (TW)

(72) Inventors: San-Tai Hsu, Taipei City (TW); Ko-Feng Chen, New Taipei City (TW); Tien-Fu Chung, Keelung City (TW)

(21) Appl. No.: 14/331,226

(22) Filed: Jul. 15, 2014

(30) Foreign Application Priority Data
Aug. 16, 2013 (TW) 102129540

(51) Int. Cl. G06F 1/16

(52) U.S. Cl. CPC G06F 1/1662
USPC 361/679.09

(57) ABSTRACT

The present invention discloses a keyboard module capable of supporting a portable electronic device. The keyboard module includes a keyboard base and a supporting mechanism, and the supporting mechanism is disposed on the keyboard base. A containing space is formed inside the supporting mechanism, and the supporting mechanism includes at least one track and a supporting device. The at least one track is disposed in the containing space, and the supporting device is slidably disposed inside the containing space. The supporting device slides along the at least one track to extend outside the containing space to a supporting position for supporting the portable electronic device.

### BACKGROUND OF THE INVENTION

1. Field of the Invention

The present invention relates to a keyboard module capable of supporting a portable electronic device, and more specifically, to a keyboard module with a supporting mechanism capable of supporting a portable electronic device and being contained.

2. Description of the Prior Art

In the market of electronic products, a portable electronic device, such as a tablet computer, is a very popular product, and the tablet computer can be used with a keyboard base, so that the keyboard base can support the tablet computer or can operate as an input interface. For example, as the tablet computer is to be used as a normal notebook computer, the tablet computer can be inserted to the keyboard base. However, there is only a single slot of the conventional keyboard base for connecting the tablet computer, so that a user only can use the tablet computer at a fixed angle. Furthermore, the single slot cannot be received in the keyboard base, so that this structural design occupies mechanical space and affects an outward appearance of the keyboard module as it is not necessary to use the keyboard function. Therefore, it is an important issue to design a keyboard module capable of supporting the tablet computer stably and adjusting an angle between the tablet computer and the keyboard module.

### SUMMARY OF THE INVENTION

The present invention is to provide a keyboard module with a supporting mechanism capable of supporting a portable electronic device and being contained, to solve above problems.

According to the disclosure, a keyboard module includes a keyboard base and a supporting mechanism. The supporting mechanism is disposed on the keyboard base. A containing space is formed inside the supporting mechanism, and the supporting mechanism includes at least one track and a supporting device. The at least one track is disposed in the containing space. The supporting device is slidably disposed inside the containing space, and the supporting device slides along the at least one track to extend outside the containing space to a supporting position for supporting a portable electronic device.

According to the disclosure, the supporting device comprises an engaging portion, the supporting mechanism further comprises a locating block disposed inside the containing space, and the engaging portion is for engaging with the locating block, so as to fix the supporting device in a fixed position.

According to the disclosure, the keyboard module further includes a trigger component connected to the locating block and being for driving the locating block to separate from the engaging portion as the trigger component is pushed.

According to the disclosure, the supporting mechanism further includes a driving unit and two stoppers. The driving unit is for driving the supporting device to move from the fixed position to the supporting position after the locating block is separated from the engaging portion. The two stoppers are disposed on a side of the containing space and are for stopping the supporting device as the supporting device moves to the supporting position.

According to the disclosure, the driving unit includes two first magnetic components and two second magnetic components. The two first magnetic components are disposed on the other side of the containing space. The two second magnetic components are disposed on the supporting device. The two first magnetic components and two second magnetic components have same poles, and the supporting device moves from the fixed position to the supporting position by a magnetic repulsive force generated between the two first magnetic components and the two second magnetic components after the locating block is separated from the engaging portion.

According to the disclosure, the driving unit further includes two third magnetic components disposed on the side of the containing space. The two second magnetic components and the two third magnetic components have opposite poles, and the supporting device is fixed on the supporting position by a magnetic attraction force between the two third magnetic components and the two second magnetic components.

According to the disclosure, the driving unit comprises a resilient component, an end of the resilient component is connected to the other side of the containing space, the other end of the resilient component is connected to the supporting device, and the resilient component is for providing a resilient force to drive the supporting device to move from the fixed position to the supporting position after the locating block is separated from the engaging portion.

According to the disclosure, the keyboard module further comprises two tracks, a fixing block is disposed on each track, the supporting device further comprises two supporting units, and each supporting unit includes a sliding component, a first resilient component, a supporting component, a second resilient component and a linking component. A slot and a contact portion are formed on the sliding component. An end of the first resilient component is disposed on an end of the slot. The supporting component includes a shaft on an end, the supporting component is pivoted to the other end of the slot by the shaft, and a protrusion is formed on the supporting component. The second resilient component sheathes the shaft and is for driving the supporting component to pivot. A first end of the linking component is connected to the other end of the first resilient component. A second end of the linking component is connected to the end of the supporting component. A driving block is disposed on a side of the linking component facing the corresponding track, and the fixing block contacts against the corresponding driving block as the supporting device slides along the two tracks in a first direction, so as to drive the corresponding driving block and the linking component to slides in a second direction opposite to the first direction, so that the linking component drives the supporting component to pivot in a first pivoting direction to support the portable electronic device after the protrusion of the supporting component contacts against the contact portion.

According to the disclosure, the supporting device further comprises a first connector for connecting a second connector of the portable electronic device, so as to transmit signals between the keyboard module and the portable electronic device.

According to the disclosure, a first magnetic attracting component is disposed on the first connector, a second magnetic attracting component is disposed on the second connector of the portable electronic device, and the first magnetic attracting component and the second magnetic attracting component are attractive to each other.

According to the disclosure, as the supporting device slides along the two tracks in the second direction opposite to the first direction, each driving block is separated from the corresponding fixing block, the first resilient component provides the resilient force to push the linking component in the first direction, the second resilient component drives the supporting component to pivot in a second pivoting direction opposite to the first pivoting direction, so that the supporting device slides into the containing space after the supporting component is contained in the slot.

According to the disclosure, the keyboard module further includes a fixing component pivoted to the keyboard base, and the fixing component is for pivoting to contact against the side of the portable electronic device as the portable electronic device is folded with the keyboard module, so as to prevent the portable electronic device from moving relative to the keyboard base.

According to the disclosure, the keyboard module further includes at least one slip-resistant component disposed under the keyboard base.

According to the disclosure, the supporting mechanism is movably installed on the keyboard base.

The present invention is to provide the keyboard module for supporting the portable electronic device, and the supporting mechanism of the keyboard module can be received in the containing space. Therefore, as the keyboard module is not used, the supporting mechanism is able to be received in the containing space, so as to save the mechanical space for the keyboard module. Moreover, the supporting mechanism of the present invention can be designed to be movably installed on the keyboard base, so that the user can adjust the angle between the portable electronic device and the keyboard base by moving the supporting mechanism relative to the keyboard base in different positions, so as to meet different requirements. As a result, it solves the problems that there is only a single slot of the conventional keyboard base for connecting the portable electronic device at a fixed angle, and the slot cannot be received in the keyboard base so that the slot occupies the mechanical space.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a keyboard module according to an embodiment of the present invention.

FIG. 2 is a diagram of the keyboard module in another view according to the embodiment of the present invention.

FIG. 3 is an inner structural diagram of a supporting mechanism according to the embodiment of the present invention.

FIG. 4 is a partial enlarged diagram of the supporting mechanism according to the embodiment of the present invention.

FIG. 5 is a diagram illustrating that a supporting device is accommodated in a containing space according to the embodiment of the present invention.

FIG. 6 and FIG. 7 are diagrams of a driving unit and the supporting device in different positions according to another embodiment of the present invention.

FIG. 8 is a partial structural diagram of a keyboard base according to the embodiment of the present invention.

FIG. 9 is a partial structural diagram of the supporting device according to the embodiment of the present invention.

FIG. 10 and FIG. 11 are sectional views along line A-A′ shown in FIG. 3 of the keyboard module in different states according to the embodiment of the present invention.

FIG. 12 and FIG. 13 are diagrams illustrating that the supporting mechanism supports a portable electronic device at different angles according to the embodiment of the present invention.

FIG. 14 is a diagram illustrating that the keyboard module is folded with the portable electronic device according to the embodiment of the present invention.

### DETAILED DESCRIPTION

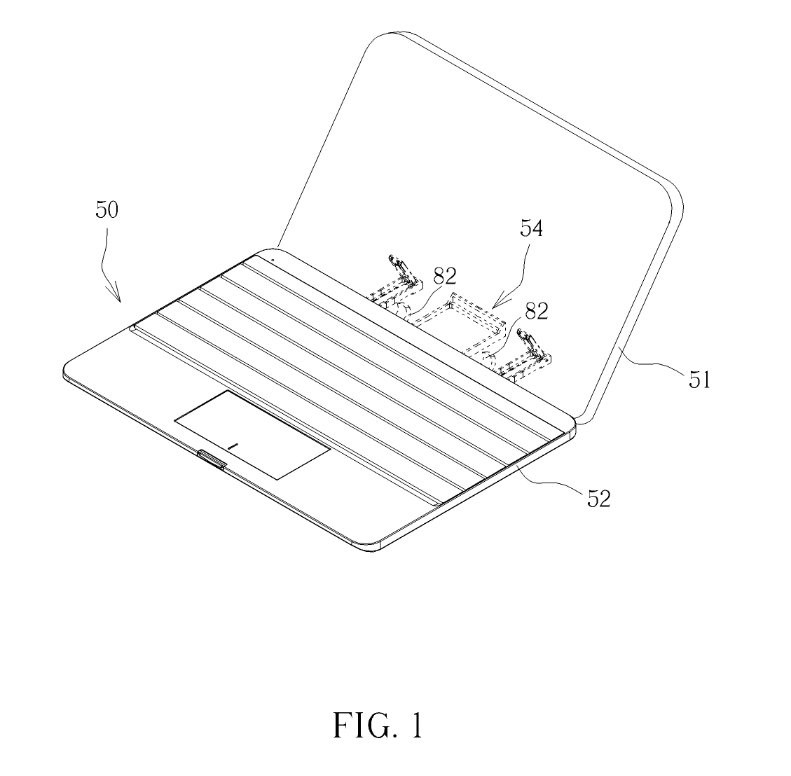

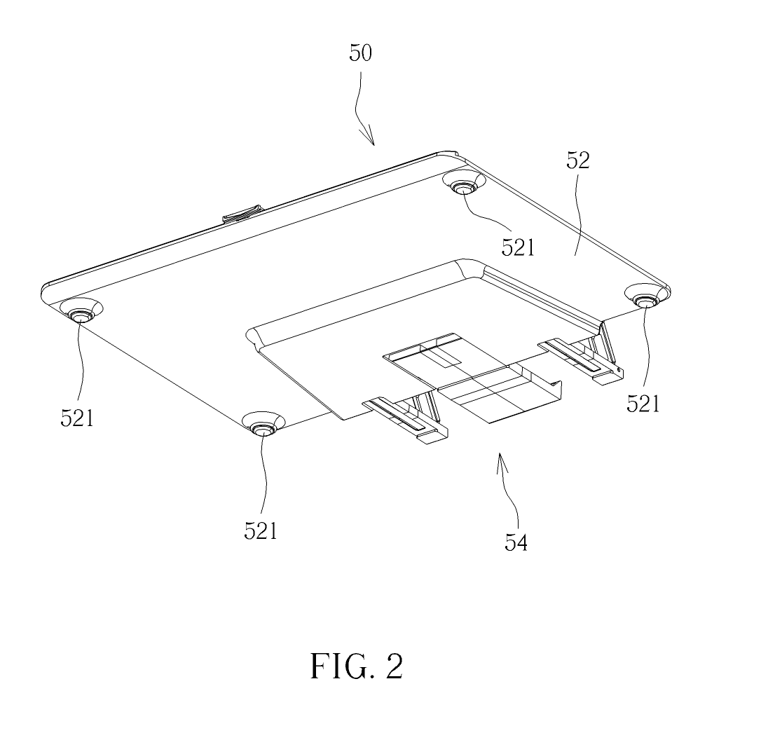

Please refer to FIG. 1 and FIG. 2. FIG. 1 is a diagram of a keyboard module 50 according to an embodiment of the present invention. FIG. 2 is a diagram of the keyboard module 50 in another view according to the embodiment of the present invention. The keyboard module 50 can be used for supporting and fixing a portable electronic device 51. The portable electronic device 51 can be a tablet computer. That is, the portable electronic device 51 is detachably installed on the keyboard module 50. The keyboard module 50 includes a keyboard base 52 and a supporting mechanism 54. A plurality of keycaps or a touchpad can be disposed on the keyboard base 52 and for facilitating a user to input various commands to the portable electronic device 51. The supporting mechanism 54 is disposed on the keyboard base 52. In addition, at least one slip-resistant component 521 can be disposed under the keyboard base 52, so as to prevent the keyboard base 52 from slipping relative to a supporting surface when the keyboard base 52 is disposed on the supporting surface, as shown in FIG. 2. In this embodiment, the keyboard module 50 can include four slip-resistant components 521 disposed on four corners under the keyboard base 52.

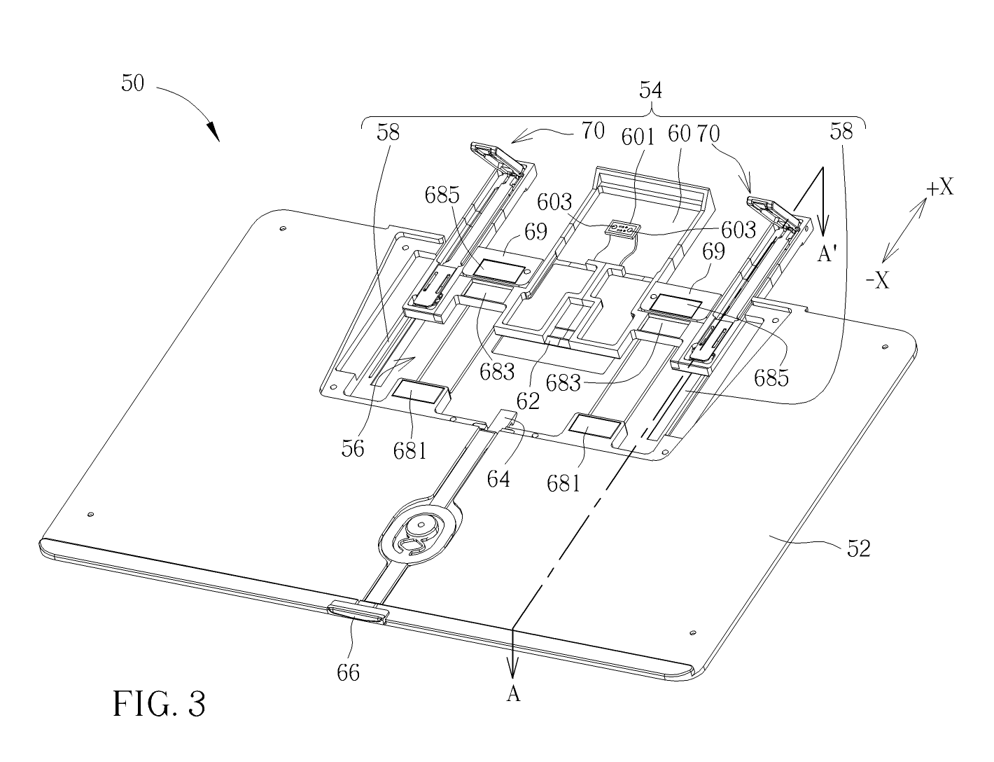

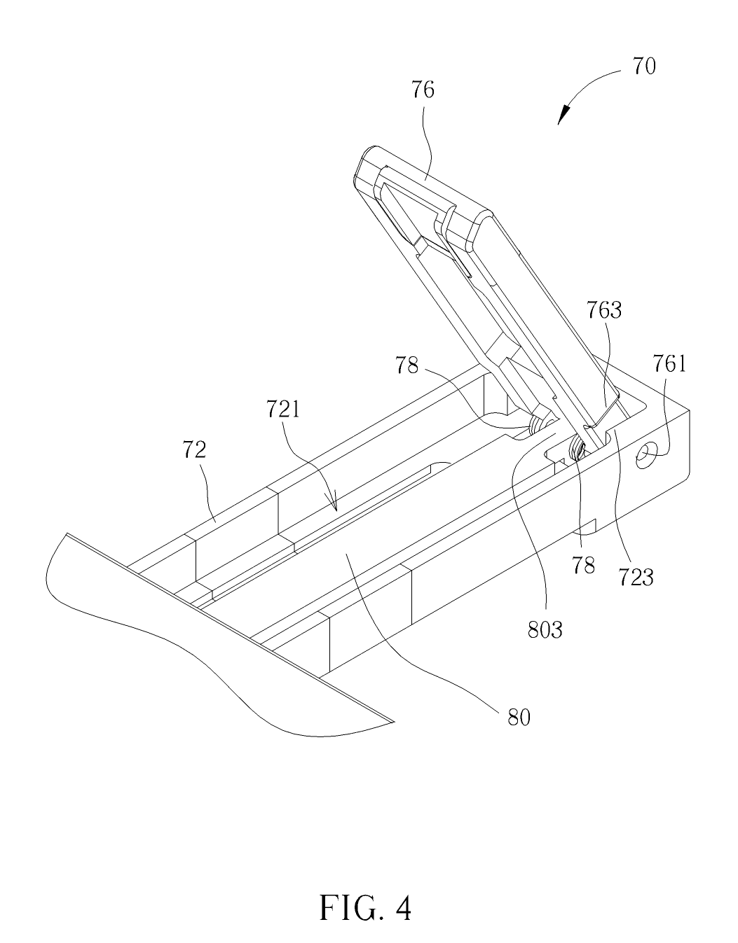

Please refer to FIG. 1, FIG. 3 and FIG. 4. FIG. 3 is an inner structural diagram of the supporting mechanism 54 according to the embodiment of the present invention. FIG. 4 is a partial enlarged diagram of the supporting mechanism 54 according to the embodiment of the present invention. As shown in FIG. 3, a containing space 56 is formed inside the supporting mechanism 54, and the supporting mechanism 54 includes at least one track 58 disposed in the containing space 56 and a supporting device 60. In this embodiment, the supporting mechanism 54 can include two tracks 58 disposed on two sides of the containing space 56, and the supporting device 60 can slide along the two tracks 58. A number of the track 58 is not limited to this embodiment. For example, the supporting mechanism 54 can only include one track 58, and the supporting device 60 can slide along the single track 58. In this embodiment, as shown in FIG. 1, the supporting device 60 is movably disposed inside the containing space 56, and the supporting device 60 slides along the two tracks 58 to extend outside the containing space 56 to a supporting position for supporting the portable electronic device 51. That is, as it is necessary to use the supporting device 60 to support the portable electronic device 51, the supporting device 60 can move along the two tracks 58, so that partial structure of the supporting device 60 moves outside the containing space 56. On the contrary, as it is not necessary to use the supporting device 60, the supporting device 60 can move into the containing space 56 along the two tracks 58, so that the supporting device 60 can be received in the containing space 56 completely.

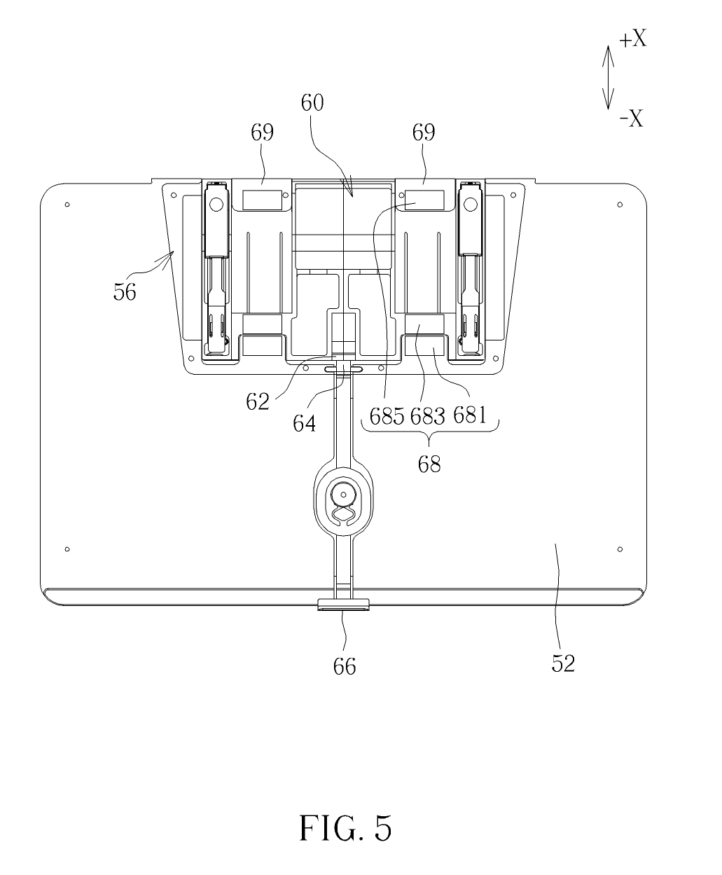

Please refer to FIG. 3 and FIG. 5. FIG. 5 is a diagram illustrating that the supporting device 60 is accommodated in the containing space 56 according to the embodiment of the present invention. As shown in FIG. 3 and FIG. 5, the supporting device 60 can include an engaging portion 62, and the supporting mechanism 54 further includes a locating block 64 disposed inside the containing space 56. As the supporting device 60 moves into the containing space 56 along the two tracks 58 and is contained inside the containing space 56 completely, the engaging portion 62 can engage with the locating block 64, so as to fix the supporting device 60 in a fixed position. In addition, the keyboard module 50 can further include a trigger component 66 connected to the locating block 64, and the trigger component 66 is for driving the locating block 64 to separate from the engaging portion 62 as the trigger component 66 is pushed. As shown in FIG. 3 and FIG. 5, the supporting mechanism 54 further includes a driving unit 68 and two stoppers 69. As the user desires to move the partial structure of the supporting device 60 out of the containing space 56, the trigger component 66 can be pushed to separate the locating block 64 from the engaging portion 62. The driving unit 68 is for driving the supporting device 60 to move from the fixed position shown in FIG. 5 to the supporting position shown in FIG. 3 after the locating block 64 is separated from the engaging portion 62. The two stoppers 69 are disposed on a side of the containing space 56 and for stopping the supporting device 60 as the supporting device 60 moves to the supporting position, so as to prevent the supporting device 60 from separating from the containing space 56 completely.

In this embodiment, the driving unit 68 can include two first magnetic components 681 and two second magnetic components 683. The two first magnetic components 681 are disposed on the other side of the containing space 56, and the two second magnetic components 683 are installed on the supporting device 60. In this embodiment, the two first magnetic components 681 and two second magnetic components 683 can be designed to have the same pole, and the supporting device 60 moves from the fixed position to the supporting position by a magnetic repulsive force generated between the two first magnetic components 681 and the two second magnetic components 683 after the locating block 64 is separated from the engaging portion 62. Furthermore, the driving unit 68 can further include two third magnetic components 685 disposed on the side of the containing space 56. In this embodiment, the two third magnetic components 685 are disposed on the two stoppers 69 respectively, and the two second magnetic components 683 and the two third magnetic components 685 can be designed to have opposite poles. The supporting device 60 is fixed on the supporting position stably by a magnetic attraction force between the two third magnetic components 685 and the two second magnetic components 683. The driving unit 68 of the present invention is not limited to be composed of the first magnetic component 681, the second magnetic component 683 and the third magnetic component 685, and numbers of magnetic components are also not limited to this embodiment.

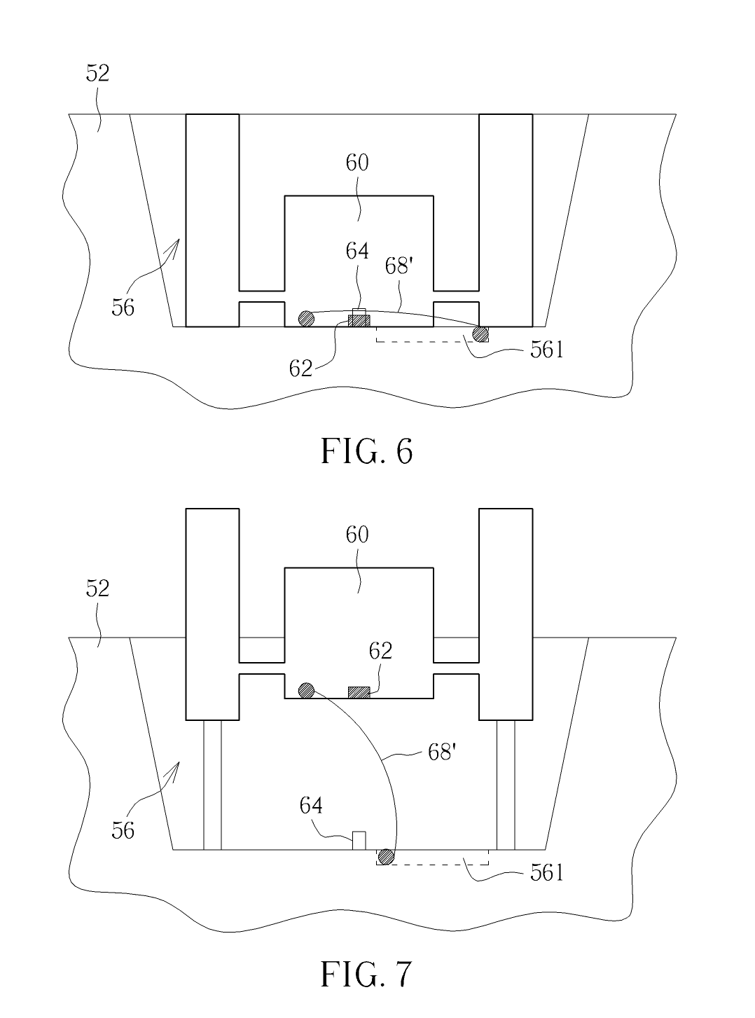

For example, please refer to FIG. 6 and FIG. 7. FIG. 6 and FIG. 7 are diagrams of a driving unit 68′ and the supporting device 60 in different positions according to another embodiment of the present invention. In this embodiment, the driving unit 68′ can be a resilient component. An end of the resilient component is movably connected to a guiding track 561 on the other side of the containing space 56, and the other end of the resilient component is connected to the supporting device 60. As shown in FIG. 6, as the supporting device 60 is in the fixed position, the resilient component is pressed and the end of the resilient component is on a right side of the guiding track 561, so that the resilient component stores elastic potential energy at this time. After the locating block 64 is separated from the engaging portion 62, the end of the resilient component moves from the right side to a left side of the guiding track 561, and the resilient component releases the elastic potential energy for providing a resilient force to drive the supporting device 60 to move from the fixed position to the supporting position, as shown in FIG. 7.

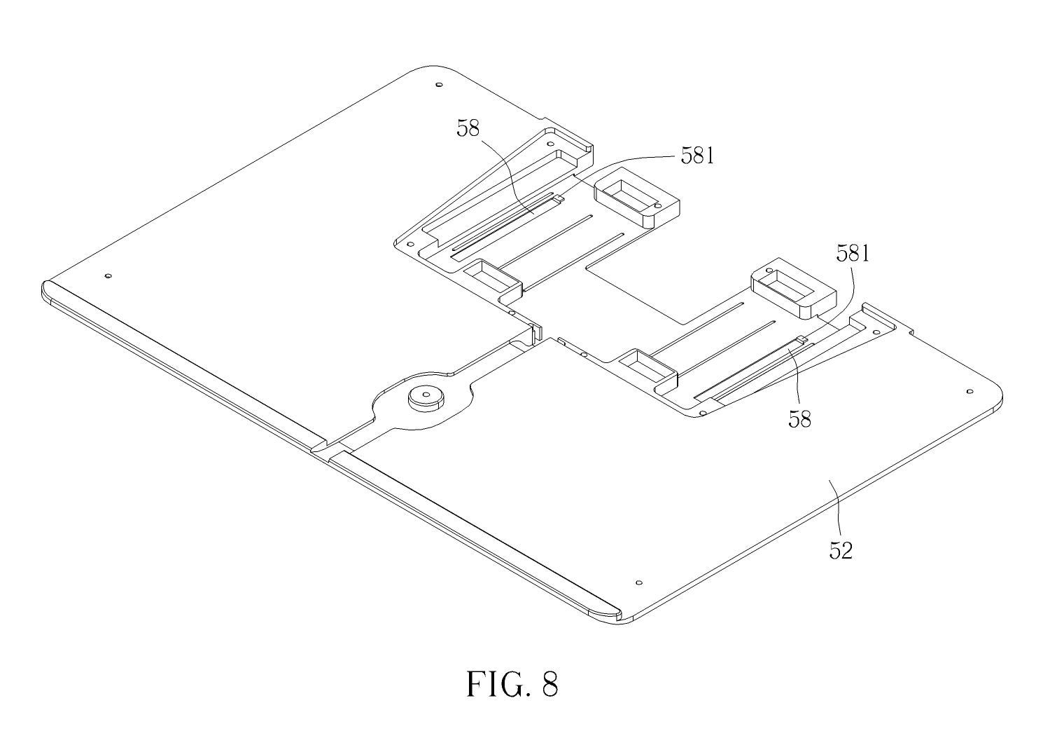

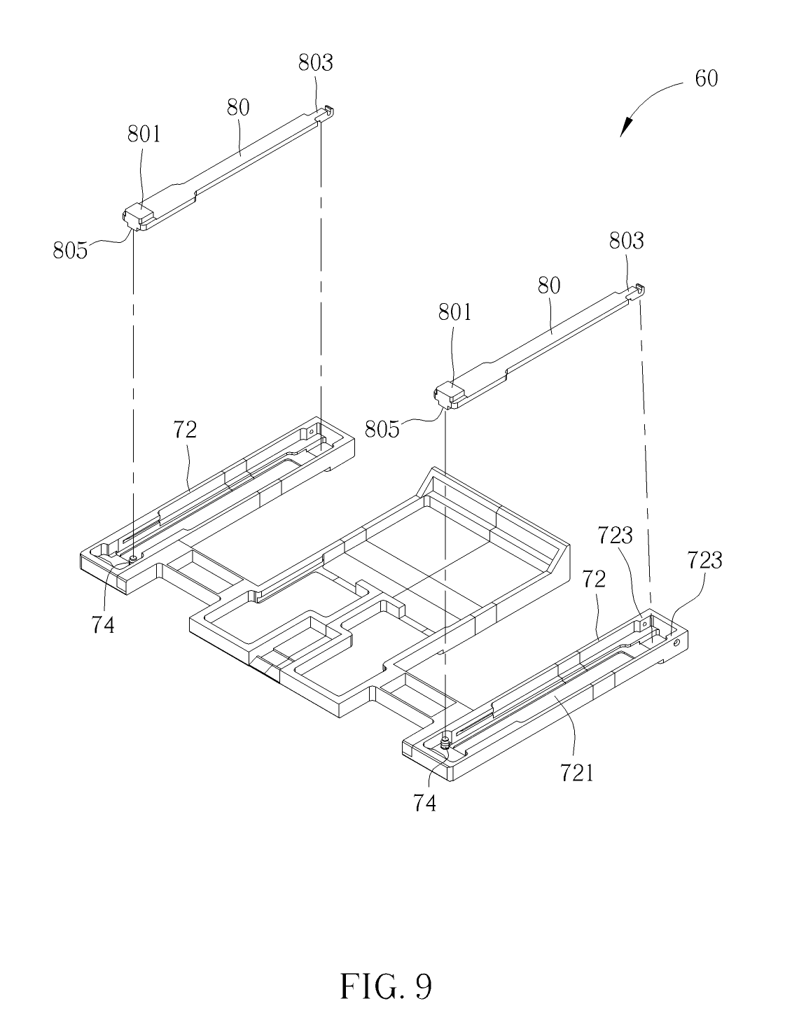

Please refer to FIG. 3, FIG. 4, FIG. 8 and FIG. 9. FIG. 8 is a partial structural diagram of the keyboard base 52 according to the embodiment of the present invention. FIG. 9 is a partial structural diagram of the supporting device 60 according to the embodiment of the present invention. The keyboard module 50 includes the two tracks 58, and a fixing block 581 is disposed on each track 58. As shown in FIG. 3, FIG. 4 and FIG. 9, the supporting device 60 includes two supporting units 70, and each supporting unit 70 includes a sliding component 72, a first resilient component 74, a supporting component 76, a second resilient component 78 and a linking component 80. A slot 721 and a contact portion 723 are formed on the sliding component 72, and an end of the first resilient component 74 is disposed on an end of the slot 721. The supporting component 76 is disposed on the slot 721. The supporting component 76 includes a shaft 761 on an end, and the supporting component 76 is pivoted to the other end of the slot 721 by the shaft 761. A protrusion 763 is formed on the supporting component 76. The second resilient component 78 sheathes the shaft 761 and is for driving the supporting component 76 to pivot. A first end 801 of the linking component 80 is connected to the other end of the first resilient component 74, and a second end 803 of the linking component 80 is connected to the shaft 761 of the supporting component 76. A driving block 805 is disposed on a side of the linking component 80 facing the corresponding track 58.

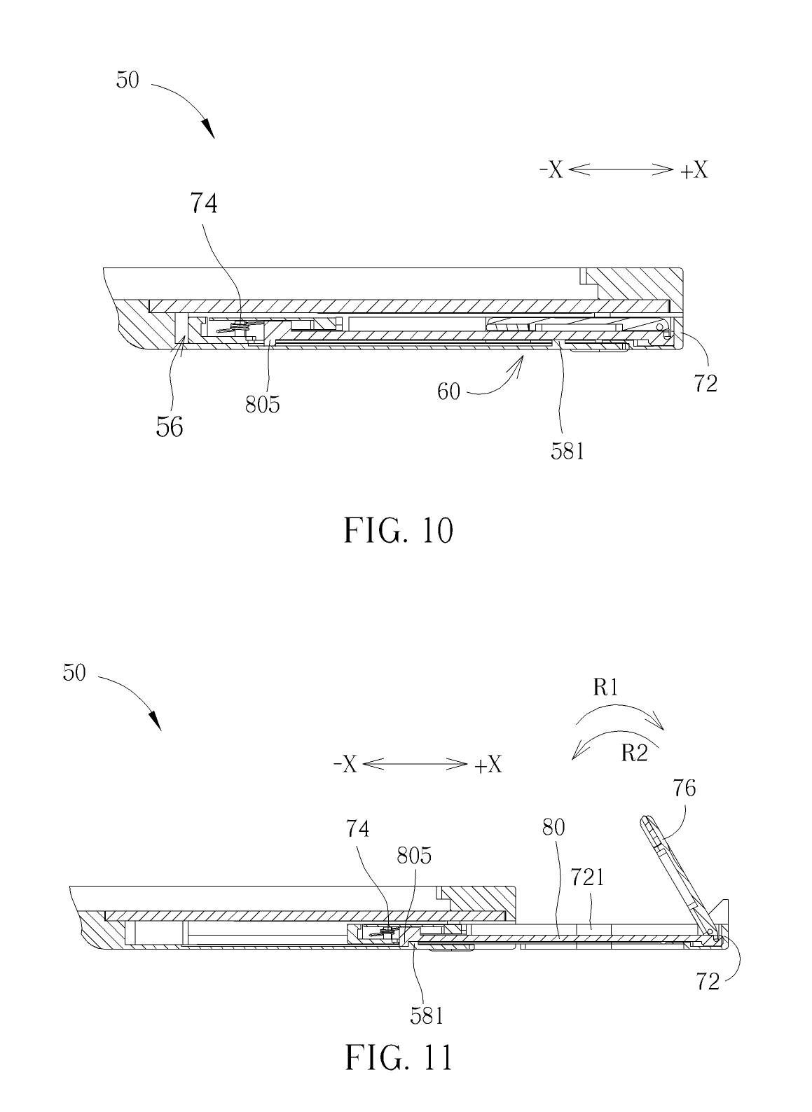

An operating procedure of the keyboard module 50 of the present invention is described as follows. Please refer to FIG. 3 to FIG. 6 and FIG. 9 to FIG. 11. FIG. 10 and FIG. 11 are sectional views along line A-A′ shown in FIG. 3 of the keyboard module 50 in different states according to the embodiment of the present invention. As the user desires to dispose the portable electronic device 51 on the keyboard module 50, the trigger component 66 is pushed to separate the locating block 64 from the engaging portion 62. At this time, the supporting device 60 moves in a first direction (+X direction) from the fixed position by the magnetic repulsive force generated between the two first magnetic components 681 and the two second magnetic components 683 and the magnetic attraction force between the two third magnetic components 685 and the two second magnetic components 683. In a procedure of moving the supporting device 60 from the fixed position to the supporting position, as shown in FIG. 11, the fixing block 581 of each track 58 contacts against the corresponding driving block 805, so as to drive the corresponding driving block 805 and the linking component 80 to slide in a second direction (−X direction) opposite to the first direction (+X direction), and the linking component 80 presses the first resilient component 74. As shown in FIG. 9, the second end 803 of the linking component 80 can be a hook-shaped portion and connected to the shaft 761 of the supporting component 76, so that the linking component 80 moves in the −X direction to drive the supporting component 76 to pivot in a first pivoting direction R1, so as to open up the supporting component 76. As the supporting device 60 moves to the supporting position and after the protrusion 763 of the supporting component 76 contacts against the contact portion 723, the supporting component 76 can support the portable electronic device 51 shown in FIG. 1. As the user desires to contain the supporting device 60 in the containing space 56, the supporting device 60 can be forced to slides along the two tracks 58 in the −X direction. At this time, each driving block 805 is separated from the corresponding fixing block 581, so that the first resilient component 74 provides the resilient force to push the linking component 80 in the first direction (+X direction), and the second resilient component 78 sheathing the shaft 761 of the supporting component 76 drives the supporting component 76 to pivot in a second pivoting direction R2 opposite to the first pivoting direction R1, so that the supporting device 60 slides into the containing space 56 after the supporting component 76 is contained in the slot 761, so as to finish steps of containing the supporting device 60.

Please refer to FIG. 1 and FIG. 3. The supporting device 60 of the present invention can further include a first connector 601 for connecting a second connector (not shown in figures) of the portable electronic device 51, so as to transmit signals between the keyboard module 50 and the portable electronic device 51. Transmission of signals between the keyboard module 50 and the portable electronic device 51 is not limited to this embodiment. For example, two wireless communication modules can be disposed on the keyboard module 50 and the portable electronic device 51 respectively, so as to transmit signals by wireless communication. Moreover, in this embodiment, a first magnetic attracting component 603 can be disposed on the first connector 601, and a second magnetic attracting component (not shown in figures) can be disposed on the second connector of the portable electronic device 51. The first magnetic attracting component 603 and the second magnetic attracting component are attractive to each other, so that the first connector 601 of the supporting device 60 is connected to the second connector of the portable electronic device 51 stably.

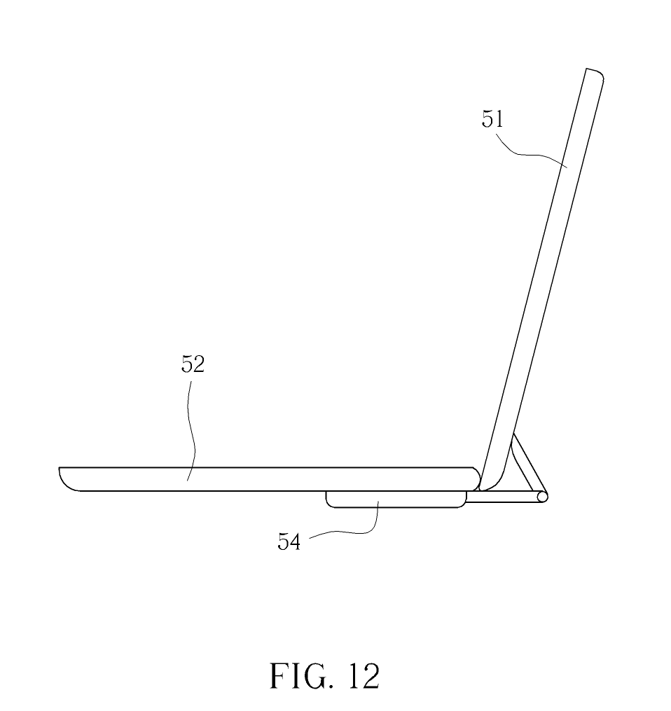

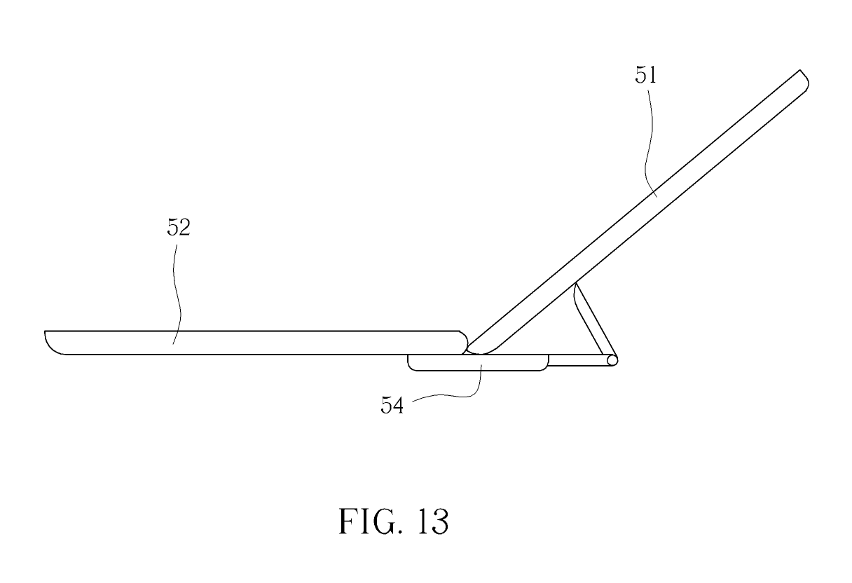

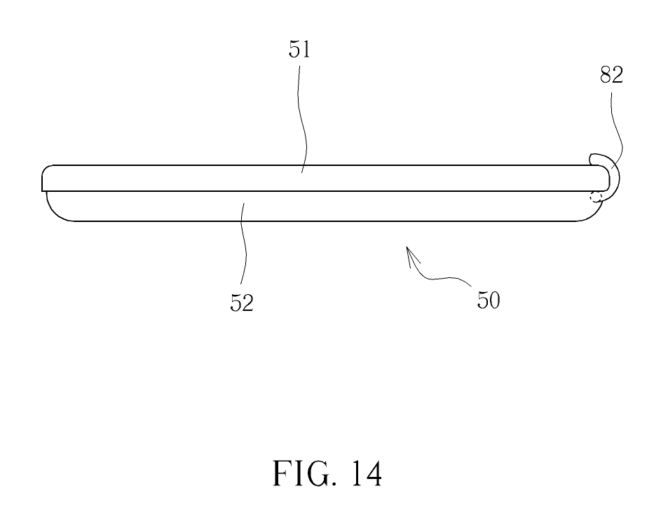

Please refer to FIG. 12 and FIG. 13. FIG. 12 and FIG. 13 are diagrams illustrating that the supporting mechanism 54 supports the portable electronic device 51 at different angles according to the embodiment of the present invention. In this embodiment, the supporting mechanism 54 is designed to be movably installed on the keyboard base 52. That is, as shown in FIG. 12 and FIG. 13, the user can adjust an angle between the portable electronic device 51 and the keyboard base 52 by moving the supporting mechanism 54 relative to the keyboard base 52 indifferent positions, so as to meet different requirements. A mechanical design for moving the supporting mechanism 54 relative to the keyboard base 52 can be a rail mechanism, but is not limited to it. Mechanisms capable of moving the supporting mechanism 54 relative to the keyboard base 52 are within the scope of the present invention. Please refer to FIG. 14. FIG. 14 is a diagram illustrating that the keyboard module 50 is folded with the portable electronic device 51 according to the embodiment of the present invention. The keyboard module 50 of the present invention can further include a fixing component 82 pivoted to the keyboard base 52, and the fixing component 82 is for pivoting to contact against the side of the portable electronic device 51 as the portable electronic device 51 is folded with the keyboard module 50, so as to prevent the portable electronic device 51 from moving relative to the keyboard base 52. Therefore, as the user desires to carry the keyboard module 50 and the portable electronic device 51, the keyboard module 50 can be folded with the portable electronic device 51 and the fixing component 82 contacts against the side of the portable electronic device 51, so as to fix the keyboard module 50 and the portable electronic device 51.

In contrast to the prior art, the present invention is to provide the keyboard module for supporting the portable electronic device, and the supporting mechanism of the keyboard module can be received in the containing space. Therefore, as the keyboard module is not used, the supporting mechanism is able to be received in the containing space, so as to save the mechanical space for the keyboard module. Moreover, the supporting mechanism of the present invention can be designed to be movably installed on the keyboard base, so that the user can adjust the angle between the portable electronic device and the keyboard base by moving the supporting mechanism relative to the keyboard base in different positions, so as to meet different requirements. As a result, it solves the problems that there is only a single slot of the conventional keyboard base for connecting the portable electronic device at a fixed angle, and the slot cannot be received in the keyboard base so that the slot occupies the mechanical space.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A keyboard module, comprising:
a keyboard base; and
a supporting mechanism disposed on the keyboard base, a containing space being formed inside the supporting mechanism, and the supporting mechanism comprising:
at least one track disposed in the containing space; and
a supporting device slidably disposed inside the containing space, the supporting device sliding along the at least one track to extend outside the containing space to a supporting position for supporting a portable electronic device.

2. The keyboard module of claim 1, wherein the supporting device comprises an engaging portion, the supporting mechanism further comprises a locating block disposed inside the containing space, and the engaging portion is for engaging with the locating block, so as to fix the supporting device in a fixed position.

3. The keyboard module of claim 2, further comprising a trigger component connected to the locating block and being for driving the locating block to separate from the engaging portion as the trigger component is pushed.

4. The keyboard module of claim 3, wherein the supporting mechanism further comprises:
a driving unit for driving the supporting device to move from the fixed position to the supporting position after the locating block is separated from the engaging portion; and
two stoppers disposed on a side of the containing space and being for stopping the supporting device as the supporting device moves to the supporting position.

5. The keyboard module of claim 4, wherein the driving unit comprises:
two first magnetic components disposed on the other side of the containing space; and
two second magnetic components disposed on the supporting device, the two first magnetic components and two second magnetic components having same poles, and the supporting device moving from the fixed position to the supporting position by a magnetic repulsive force generated between the two first magnetic components and the two second magnetic components after the locating block is separated from the engaging portion.

6. The keyboard module of claim 5, wherein the driving unit further comprises two third magnetic components disposed on the side of the containing space, the two second magnetic components and the two third magnetic components have opposite poles, and the supporting device is fixed on the supporting position by a magnetic attraction force between the two third magnetic components and the two second magnetic components.

7. The keyboard module of claim 4, wherein the driving unit comprises a resilient component, an end of the resilient component is connected to the other side of the containing space, the other end of the resilient component is connected to the supporting device, and the resilient component is for providing a resilient force to drive the supporting device to move from the fixed position to the supporting position after the locating block is separated from the engaging portion.

8. The keyboard module of claim 1, wherein the keyboard module further comprises two tracks, a fixing block is disposed on each track, the supporting device further comprises two supporting units, and each supporting unit comprises:
a sliding component whereon a slot and a contact portion are formed;
a first resilient component, an end of the first resilient component being disposed on an end of the slot;
a supporting component disposed on the slot, the supporting component comprising a shaft on an end, the supporting component being pivoted to the other end of the slot by the shaft, and a protrusion being formed on the supporting component;
a second resilient component sheathing the shaft and for driving the supporting component to pivot; and
a linking component, a first end of the linking component being connected to the other end of the first resilient component, a second end of the linking component being connected to the end of the supporting component, a driving block being disposed on a side of the linking component facing the corresponding track, and the fixing block contacting against the corresponding driving block as the supporting device slides along the two tracks in a first direction, so as to drive the corresponding driving block and the linking component to slides in a second direction opposite to the first direction, so that the linking component drives the supporting component to pivot in a first pivoting direction to support the portable electronic device after the protrusion of the supporting component contacts against the contact portion.

9. The keyboard module of claim 8, wherein the supporting device further comprises a first connector for connecting a second connector of the portable electronic device, so as to transmit signals between the keyboard module and the portable electronic device.

10. The keyboard module of claim 9, wherein a first magnetic attracting component is disposed on the first connector, a second magnetic attracting component is disposed on the second connector of the portable electronic device, and the first magnetic attracting component and the second magnetic attracting component are attractive to each other.

11. The keyboard module of claim 8, wherein as the supporting device slides along the two tracks in the second direction opposite to the first direction, each driving block is separated from the corresponding fixing block, the first resilient component provides the resilient force to push the linking component in the first direction, the second resilient component drives the supporting component to pivot in a second pivoting direction opposite to the first pivoting direction, so that the supporting device slides into the containing space after the supporting component is contained in the slot.

12. The keyboard module of claim 1, further comprising a fixing component pivoted to the keyboard base, and the fixing component being for pivoting to contact against the side of the portable electronic device as the portable electronic device is folded with the keyboard module, so as to prevent the portable electronic device from moving relative to the keyboard base.

13. The keyboard module of claim 1, further comprising at least one slip-resistant component disposed under the keyboard base.

14. The keyboard module of claim 1, wherein the supporting mechanism is movably installed on the keyboard base.
